(19) United States
(12) Patent Application Publication
(10) Pub. No.: US 2026/0216631 A1
(43) Pub. Date: Jul. 30, 2026

(54) AUTOMATIC PROPORTIONING AND SPARY SYSTEM OF COMPOUND ULTRA-FINE DUST CAPTURE AGENT

(71) Applicant: Anhui University of Science and Technology, Huainan City (CN)

(72) Inventors: Changji WANG, Huainan City (CN); Qingju QIN, Huainan City (CN); Jichao ZHU, Huainan City (CN); Jian HE, Huainan City (CN); Yuanyuan ZHU, Huainan City (CN); Shun YU, Huainan City (CN); Hanxu LI, Huainan City (CN)

(73) Assignee: Anhui University of Science and Technology, Huainan City (CN)

(21) Appl. No.: 19/560,126

(22) Filed: Mar. 8, 2026

Related U.S. Application Data
(63) Continuation of application No. PCT/CN2026/074816, filed on Jan. 26, 2026.

(30) Foreign Application Priority Data
Aug. 27, 2025 (CN) CN 202511206367.3

(51) Int. Cl. B01D 47/06

(52) U.S. Cl. CPC B01D 47/06; B01D 2247/08

(57) ABSTRACT

The present disclosure relates to a technical field of dust capture, and discloses an automatic proportioning and spray system for a composite ultra-fine dust capture agent, including a protective bin, in which a raw material enclosure and a mixing enclosure are respectively set, a control module set on a vertical surface of the protective bin, a funnel set on a surface of the mixing enclosure of the protective bin, and an agent hopper set on a surface of the raw material enclosure of the protective bin. The present disclosure helps avoid uneven concentration problems caused by sedimentation, and further improves dust capture efficiency through a circular oscillation anti sedimentation design to rotate a circular pretreatment pipe through a driving device, allowing internal chemicals to continuously oscillate under flow impact, further replacing manual proportioning and improving operational accuracy and convenience.

### TECHNICAL FIELD

The present relates to a technical field of dust capture, in particular to an automatic proportioning and spray system for a compound ultra-fine dust capture agent.

### BACKGROUND ART

The International Organization for Standardization (ISO) defines suspended solids with a particle size of less than 75 μm as dust, including various forms such as dust, mineral dust, smoke, etc The dust can be divided into inorganic dust (such as quartz and metal dust), organic dust (such as cotton, linen, flour), and mixed dust according to nature of the dust. Dust mainly comes from mechanical processing (crushing, grinding) of solid materials, combustion processes (incomplete combustion produces smoke and dust), and natural weathering. In industrial production, ore crushing can produce high-risk dust with a concentration exceeding 200 mg/m³.

A current dust control technology generally adopts a method of water mist sandblasting combined with a chemical agent to improve dust removal efficiency. However, there are two major technical bottlenecks in practical application: firstly, the chemical agent is prone to causing sedimentation due to improper concentration control; when a sediment is mixed with liquid, it will cause uneven distribution of the chemical agent. Actual test data shows that in this case, a dust removal efficiency may decrease by more than 20%. Secondly, an existing proportioning system mostly adopts a semi-automatic mode of manual intervention, which has problems such as a proportioning error rate of up to ±10% and cumbersome operation processes, seriously affecting stability and economy of dust control. These technical defects directly constrain performance optimization of industrial dust removal systems.

In view of above problems, an automatic proportioning and spray system for a compound ultra-fine dust capture agent is proposed to solve the above problems.

### SUMMARY

### Technical Problems Solved

In view of shortcomings of prior art, the present disclosure provides an automatic proportioning and spray system for a compound ultra-fine dust capture agent, which has advantages of high precision of fully automated proportioning and convenient operation, solves problem that is difficult to automate proportioning and proportioning of dust in the prior art, which is easy to cause precipitation and low efficiency of dust capture.

### Technical Solution

To achieve above objectives, the present disclosure provides a following technical solution: an automatic proportioning and spray system for a compound ultra-fine dust capture agent, including: a protective bin, where a raw material enclosure and a mixing enclosure are arranged inside the protective bin; a control module is set on one side of an outer surface of the protective bin, a funnel is set on a surface of the mixing enclosure of the protective bin, an agent hopper is set on a surface of the raw material enclosure of the protective bin, a spraying device is set on an other side of the outer surface of the protective bin, wherein the automatic proportioning and spray system of composite ultra-fine dust capture agent further comprises: an anti sedimentation quantitative feeding mechanism and a multi-function mixing and stirring mechanism;
the anti sedimentation quantitative feeding mechanism is set in the raw material enclosure, where the anti sedimentation quantitative feeding mechanism is used for automatic proportioning and anti precipitation of dust capture agent; and
the multi-function mixing and stirring mechanism is set in the mixing enclosure, where the multi-function mixing and stirring mechanism is used for uniform mixing of dust capture agent.

In some embodiments, the anti sedimentation quantitative feeding mechanism includes: a pretreatment pipe, both ends of the pretreatment pipe is rotatably set on an inner wall of the raw material enclosure; the pretreatment pipe is vertically fixed and connected through two circular branch pipes, and a middle of one end of the pretreatment pipe is connected to the agent hopper; a driving device is set on an outer side of the wall of the raw material enclosure, and a driving shaft of the driving device is fixedly set at an other end of the pretreatment pipe.

In some embodiments, an aggregate pipe is fixedly connected in a middle of the pretreatment pipe, where a middle of the aggregate pipe is equipped with a liquid outlet hole and a fixed ring is set on an outer surface of the liquid outlet hole; a sliding pipe is set in a middle of the fixed ring in a sliding manner, and a liquid outlet groove is set at an end of the sliding pipe of the aggregate pipe, a conical liquid outlet block is fixedly connected at an other end of the sliding pipe of the aggregate pipe.

In some embodiments, a reset spring is set on an outer surface of the sliding pipe, an end of the reset spring is fixedly set on the fixed ring, and an other end of the reset spring is fixedly set on a surface of the conical liquid outlet block; where a curved extrusion plate is set on each of two sides of an outer surface of the conical liquid outlet block; a curved extrusion groove is set on the curved extrusion plate, and is coaxially set with the aggregate pipe; a liquid collection bin is set below curved extrusion plates set on two sides of the outer surface of the conical liquid outlet block, where a pressure boosting device is set in the liquid collection bin; the pressure boosting device is fixedly connected to the funnel through a pipeline.

In some embodiments, the multi-function mixing and stirring mechanism includes: a transmission rod, which is rotatably set at a base of the mixing enclosure, where a scraper is rotatably set at the base of the mixing enclosure, and a middle of the scraper is fixedly set on an outer surface of the transmission rod.

In some embodiments, two stirring shafts are set at an end of the transmission rod away from the scraper, and filtrate holes are uniformly set on each of the two stirring shafts, where an extrusion rod is fixed on each of both sides of each of the two stirring shafts.

In some embodiments, two circular baffle plates are symmetrically set on an inner wall of the mixing enclosure, and guide grooves are uniformly set at both ends of each of the two circular baffle plates; an arc-shaped extrusion groove is set on an inner surface of each of the two circular baffle plates, where two ends of the extrusion rod are slidably set in the arc-shaped extrusion groove; an elastic telescopic rods are uniformly set in the mixing enclosure, one end of each of the elastic telescopic rods is set on one of the two circular baffle plates and an other end of each of the elastic telescopic rods is set on an other one of the two circular baffle plates.

### Beneficial effect

Compared with the prior art, the present disclosure provides an automatic proportioning and spray system for a compound ultra-fine dust capture agent, which has following beneficial effects:
circular oscillation anti sedimentation: the pretreatment pipe is rotated through a driving device, allowing internal chemicals to continuously oscillate under flow impact to avoid an uneven concentration problem caused by sedimentation, and further improve a dust capture efficiency.

Arc-shaped linkage quantitative discharge: spacing of an arc-shaped conical liquid outlet block) is squeezed by curved extrusion plates when the pretreatment pipe rotates, pushing a sliding pipe upward, opening a sealing liquid outlet hole; by adjusting rotating speed of the pretreatment pipe, a discharge of chemicals can be accurately controlled, furthermore replacing manual proportioning and improving operational accuracy and convenience.

Multidimensional mixing enhancement effect: a rotation of the transmission rod achieves lateral stirring, and a linkage of the circular baffle plates forms vertical flow guidance, reducing an adhesion of chemicals at base and inner wall of the mixing enclosure. Through multidimensional mixing, ensuring full contact between chemicals and liquids, maximizing dust removal efficiency.

### BRIEF DESCRIPTION OF THE DRAWINGS

FIG. 1 shows a schematic diagram of a three-dimensional structure of the present disclosure.

FIG. 2 shows a supplementary schematic diagram of the three-dimensional structure of the present disclosure.

FIG. 3 shows a schematic diagram of a connection relationship of a semi cut structure in the raw material enclosure of the present disclosure.

FIG. 4 shows an enlarged view of point A in FIG. 3 of the present disclosure.

FIG. 5 shows a schematic diagram of a connection relationship of a semi cut structure in the mixing enclosure of the present disclosure.

FIG. 6 shows a decomposition schematic diagram of a connection relationship of the multi-function mixing and stirring mechanism of the present disclosure.

FIG. 7 shows an enlarged view of point B in FIG. 6 of the present disclosure.

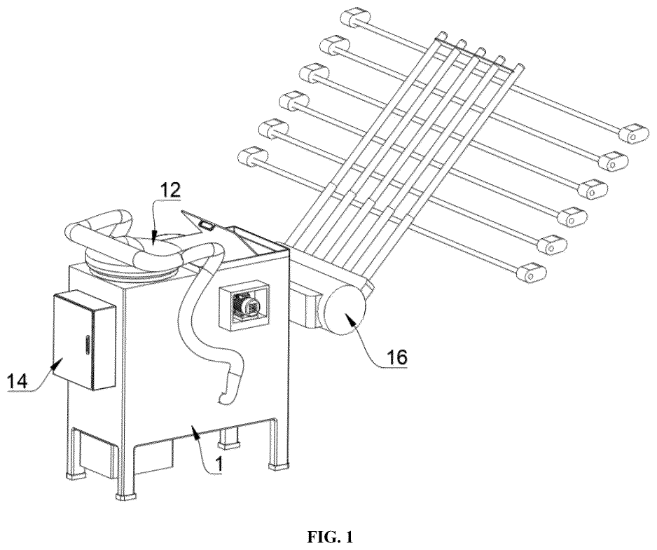

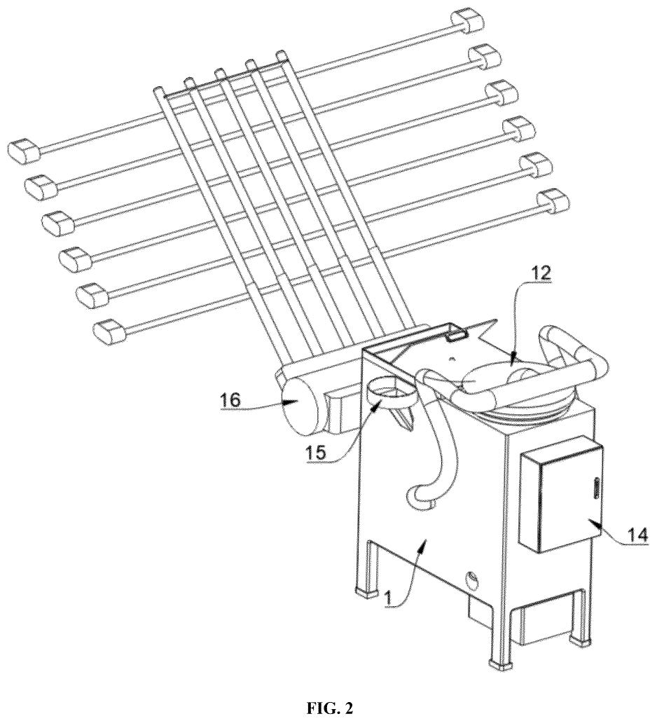

In figures:
1: protective bin; 11: raw material enclosure; 12: funnel; 13: mixing enclosure; 14: control module; 15: agent hopper; 16: spraying device;
2: anti sedimentation quantitative feeding mechanism; 21: pretreatment pipe; 22: aggregate pipe; 23: fixed ring; 24: sliding pipe; 25: reset spring; 26: conical liquid outlet block; 27: curved extrusion plate; 28: liquid collection bin; 29: pressure boosting device;
3: multi-function mixing and stirring mechanism; 31: transmission rod; 32: scraper; 33: stirring shaft; 34: extrusion rod; 35: circular baffle plate; 36: elastic telescopic rod; 37: guide groove; 38: arc-shaped extrusion groove

### DETAILED DESCRIPTION OF THE EMBODIMENTS

Technical solutions in embodiments of the present disclosure will be clearly and completely described in conjunction with accompanying drawings. Obviously, the described embodiments are only a part of embodiments of the present disclosure, not all. Based on the embodiments of the present disclosure, all other embodiments obtained by ordinary skilled persons in the art without creative labor are within a scope of protection of the present disclosure.

Referring to a figure of protection bin 17, automatic proportioning and spray system for a compound ultra-fine dust capture agent, including: a raw material enclosure 11 and a mixing enclosure 13 are arranged inside the protective bin 1; a control module 14 is set on one side of an outer surface of the protective bin 1, a funnel 12 is set on a surface of the mixing enclosure 13 of the protective bin 1, an agent hopper 15 is set on a surface of the raw material enclosure 11 of the protective bin 1, a spraying device 16 is set on an other side of the outer surface of the protective bin 1, wherein the automatic proportioning and spray system of composite ultra-fine dust capture agent further comprises: an anti sedimentation quantitative feeding mechanism 2 and a multi-function mixing and stirring mechanism 3;
the anti sedimentation quantitative feeding mechanism 2 is set in the raw material enclosure 11, where the anti sedimentation quantitative feeding mechanism 2 is used for automatic proportioning and anti precipitation of dust capture agent; and
the multi-function mixing and stirring mechanism 3 is set in the mixing enclosure 13, where the multi-function mixing and stirring mechanism 3 is used for uniform mixing of dust capture agent.

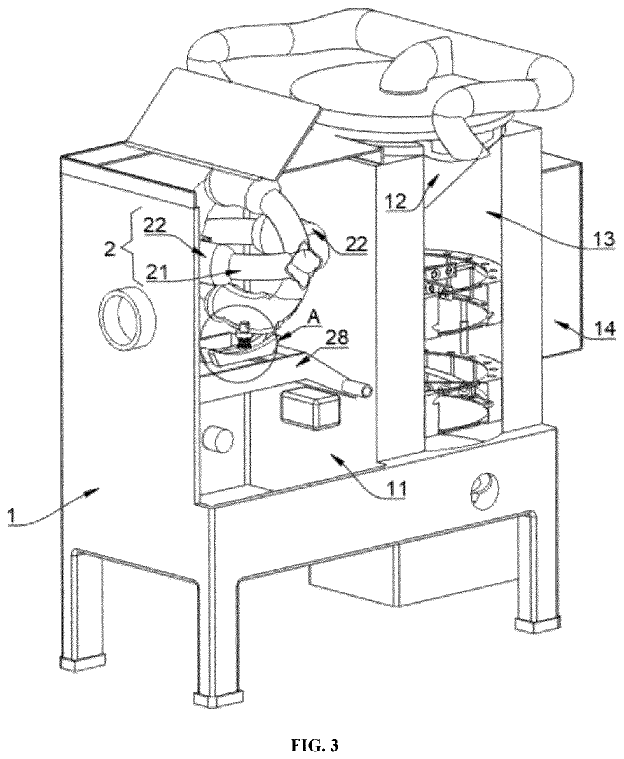

Specifically, as shown in FIG. 3, both ends of a pretreatment pipe 21 are rotatably set on an inner wall of the raw material enclosure 11; the pretreatment pipe 21 is vertically fixed and connected through two circular branch pipes, and a middle of one end of the pretreatment pipe 21 is connected to the agent hopper 15; a driving device is set on an outer side of the wall of the raw material enclosure 11, and a driving shaft of the driving device is fixedly set at an other end of the pretreatment pipe 21;
where, by setting an circular shape of the pretreatment pipe 21, when the anticipation pipe 21 is connected through the medication hopper 15 and injected with medication, a rotation of the pretreatment pipe 21 can be activated by the driving device to oscillate the medication in the pretreatment pipe 21. The continuous flow and impact of the medication in the pretreatment pipe 21 can prevent a sedimentation of the medication and reduce a problem of low dust capture effect caused by different local concentrations of the medication.

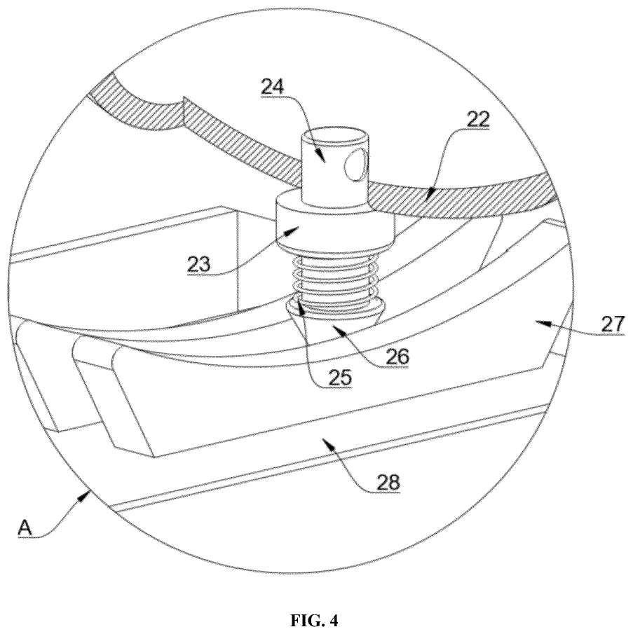

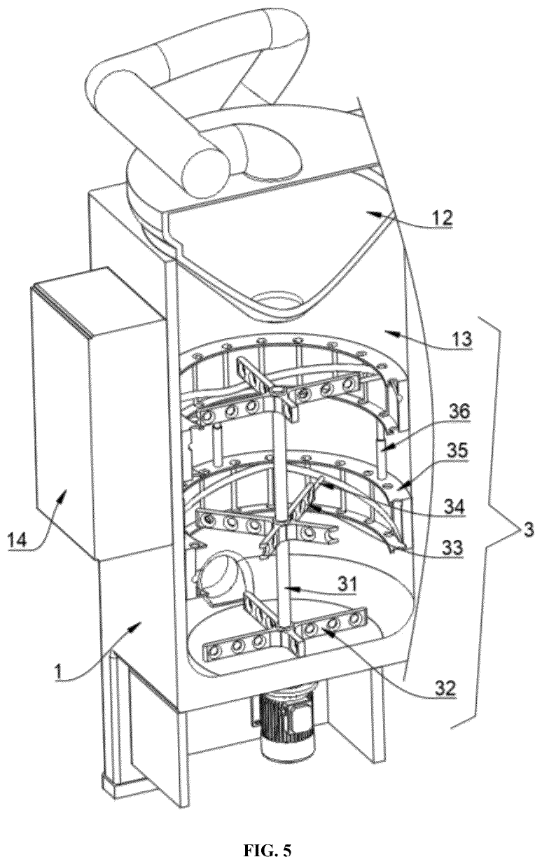

In some embodiments, as shown in FIG. 4, an aggregate pipe 22 is fixedly connected in a middle of the pretreatment pipe 21, where a middle of the aggregate pipe 22 is equipped with a liquid outlet hole and a fixed ring 23 is set on an outer surface of the liquid outlet hole; a sliding pipe 24 is set in a middle of the fixed ring 23 in a sliding manner, and a liquid outlet groove is set at an end of the sliding pipe 24 of the aggregate pipe 22, a conical liquid outlet block 26 is fixedly connected at an other end of the sliding pipe 24 of the aggregate pipe 22. A reset spring 25 is set on an outer surface of the sliding pipe 24, an end of the reset spring 25 is fixedly set on the fixed ring 23, and an other end of the reset spring 25 is fixedly set on a surface of the conical liquid outlet block 26; where a curved extrusion plate 27 is set on each of two sides of an outer surface the conical liquid outlet block 26; a curved extrusion groove is set on the curved extrusion plate 27, and is coaxially set with the aggregate pipe 22; a liquid collection bin 28 is set below curved extrusion plates 27 set on two sides of the outer surface of the conical liquid outlet block 26, where a pressure boosting device 29 is set in the liquid collection bin 28; the pressure boosting device 29 is fixedly connected to the funnel 12 through a pipeline.

Where, a diameter of a curved surface of the conical liquid outlet block 26 is slightly larger than a spacing between curved extrusion plates 27, so that the conical liquid outlet block 26 can be squeezed by curved surface of the curved extrusion plates 27 under a rotation of the pretreatment pipe 21. The conical liquid outlet block 26 drives the sliding pipe 24 to move upward, letting an end of the sliding pipe 24 and liquid outlet holes of the aggregate pipe 22 move upward, and the agent in the aggregate pipe 22 can be discharged through the liquid outlet holes of the sliding pipe 24. The present disclosure not only achieves anti sedimentation pretreatment of the agent by rotating the pretreatment pipe 21, but also controls a quantitative discharge of the agent by adjusting a rotating speed of the pretreatment pipe 21. The present disclosure can reduce an impact of manual proportioning accuracy of the medication through setting, reduce a complexity of proportioning operations, and increase a practicality of equipment.

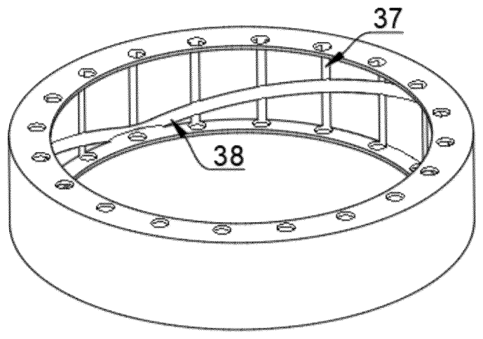

In some embodiments, as shown in FIG. 5, a transmission rod 31 is rotatably set at a base of the mixing enclosure 13, where a scraper 32 is rotatably set at the base of the mixing enclosure 13, and a middle of the scraper 32 is fixedly set on an outer surface of the transmission rod 31;
where, a driving device is also set on an other surface of the raw material enclosure 11 in the protection bin 1, and the driving shaft of the driving device is fixedly installed with the other end of the transmission rod 31. By rotating the transmission rod 31, the scraper 32 can be driven to clean a base of the raw material enclosure 11 and mix the agent with the mixed liquid to reducing a sedimentation of the agent.

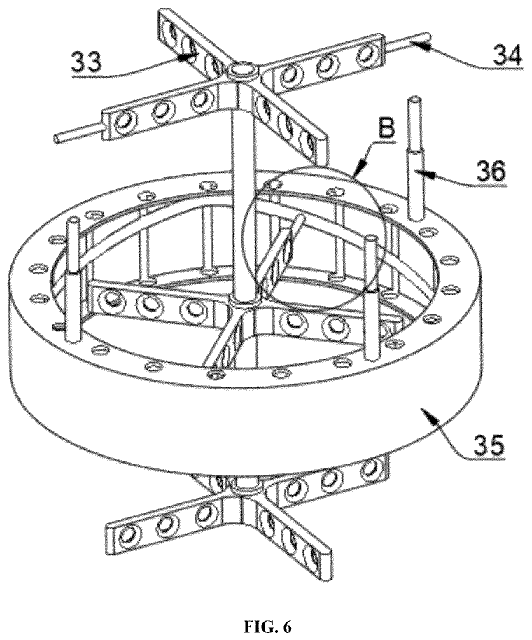

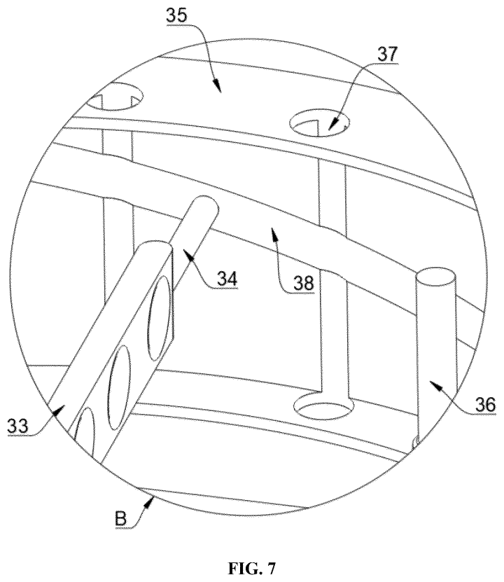

Furthermore, as shown in FIG. 6, two stirring shafts 33 are set at an end of the transmission rod 31 away from the scraper 32, and filtrate holes are uniformly set on each of the two stirring shafts 33, where an extrusion rod 34 is fixed on each of both sides of each of the stirring shafts 33. Two circular baffle plates 35 are symmetrically set on an inner wall of the mixing enclosure 13, and guide grooves 37 are uniformly set at both ends of each of the two circular baffle plates 35; an arc-shaped extrusion groove 38 is set on an inner surface of each of the two circular baffle plates 35, where two ends of the extrusion rod 34 are slidably set in the arc-shaped extrusion groove 38; an elastic telescopic rods 36 are uniformly set in the mixing enclosure 13, one end of each of the elastic telescopic rods 36 is set on one of the two circular baffle plates 35 and an other end of each of the elastic telescopic rods 36 is set on an other one of the two circular baffle plates 35.

Where, the circular baffle plates 35 can only slide up and down on the wall of the mixing enclosure 13 through a limiting device.

Where, the present disclosure sliding setting the extrusion rod 34 in the arc-shaped extrusion groove 38 set by the circular baffle plates 35, when the stirring shafts 33 are synchronously rotated by rotating the transmission rod 31, at the same time, under a extrusion rotation of the extrusion rod 34 and the arc-shaped extrusion groove 38, the circular baffle plates 35 can be driven to slide up and down on the wall of the mixing enclosure 13. Setting the guide groove 37 on the circular baffle plates 35 can guide a mixed liquid and accelerate a mixing uniformity of the mixed agent in the mixing enclosure 13.

The present disclosure not only achieves lateral stirring of the agent through a rotation of the transmission rod 31, but also vertically guides the agent through a linkage of the circular baffle plates 35. This not only can reduces an adhesion of the agent to the base and wall of the mixing enclosure 13, but also allows the agent to fully mix with the liquid through the multidimensional mixing flow of the present disclosure, thereby enabling the agent to capture dust with maximum efficiency.

The specific operation process is as follows:
s1: mixing ratio of agent:
   firstly, a certain amount of liquid is injected into the raw material enclosure 11, and then dust capturing agent is injected into the agent hopper 15. As the agent hopper 15 is connected to the pretreatment pipe 21, the dust capturing agent in the agent hopper 15 gradually flows into the pretreatment pipe 21, and then gradually flows into the aggregate pipe 22 through the pretreatment pipe 21. As shown in FIG. 4, in a initial state, the conical liquid outlet block 26 is not in contact with the curved extrusion plates 27. At this time, an elastic action of the reset spring 25 will cause the liquid outlet holes on the sliding pipe 24 to close with the aggregate pipe 22. When an operator starts the driving device set on the other surface of the raw material enclosure 11 in the protective bin 1 under a control of the control module 14, a rotation of the driving shaft through the driving device will drive the pretreatment pipe 21 to rotate, and a rotation of the pretreatment pipe 21 will synchronously drive the aggregate pipe 22 to rotate around the middle of the pretreatment pipe 21. Where, injecting dust capture agents into the pretreatment pipe 21 during a rotation, the rotation will drive the dust capture agents in the pretreatment pipe 21 continuously flowing through the pretreatment pipe, thereby preventing a sedimentation of dust capturing agents. At the same time, as the pretreatment pipe 21 rotates, due to a coaxial opening of the curved extrusion groove between the curved extrusion plates 27 and the middle of the pretreatment pipe 21, when the conical liquid outlet block 26 and the curved extrusion groove on the curved extrusion plates 27 are pressed against each other, it will drive the conical liquid outlet block 26 start driving the sliding pipe 24 to slide upward. At this time, liquid outlet holes set on the sliding pipe 24 starts to slide from a closed state to connect with the dust capture agents in the aggregate pipe 22. At this time, the dust capture agent will be guided along the liquid outlet holes of the sliding pipe 24 to the liquid collection bin 28. Through a gradual pressurization of the pressure boosting device 29, the quantitatively proportioned dust capture agent in the collection bin 28 will be discharged into the funnel 12, and then guided into the mixing enclosure 13 through the funnel 12 for preliminary mixing. Similarly, liquid located in the base of the raw material bin 11 is also transported by a booster pump into the mixing bin 13 to mix with the dust capture agents.

Furthermore, as shown in FIG. 5, The liquid and dust capture agents entering the mixing bin 13 begin to drive the transmission rod 31 to rotate under the rotation of the driving device. Under a rotation of the transmission rod 31, the scraper 32 can be driven to scrape a base of the mixing bin 13, where reducing a sedimentation and adhesion of the dust capture agent. At the same time, driving the stirring shafts 33 to rotate synchronously by the transmission rod 31 can mix the liquid and dust capture agent. A flow velocity of the mixed liquid in the mixing bin 13 can be accelerated through guide holes in the stirring shafts 33 and the scraper 32. At the same time, the vertical sliding of the return spring 25 on the wall of the mixing bin 13 is driven by a mutual squeezing of the extrusion rod 34 and the arc-shaped extrusion groove 38. Adhesion of the agents to the base and wall of the container mixing bin 13 can be reduced through a lateral stirring achieved by a transmission rod 31 rotation, and a linkage with a vertical guide formed by the circular baffle plate 35. Ensuring a multidimensional mixing of the agent and liquid are fully in contact, maximizing a dust removal efficiency.
s2: dust pre-agglomeration: spraying 0.05-0.1 μm level atomized water mist into flue gas to condense submicron particles into agglomerates larger than 1 μm.

Temperature control: spray to cool down to <70° C. (to avoid chemical decomposition).
s3: spraying agents:
   spray system: the spraying device 16 adopts a dual fluid nozzle (compressed air+solution), where a droplet size of 30-100 μm. The spraying device 16 is equipped with a pressure adjustment pump, where a pressure adjustment range is 1-6 MPa. A specific pressure adjustment value is adaptively adjusted according to an actual usage environment.

Layout: spraying device 16 adopts a matrix nozzle array, which is installed on a telescopic rod and can be adjusted in angle and height (coverage rate ≥150%).
Key parameters:
   spraying pressure: 1-6 mpa;
s4: capture reactions:
   chemical capture: dust capture agents (such as modified polyacrylamide) link dust particles through bridging action.

It should be noted that a term “including” or any other variation is intended to encompass non exclusive inclusion, so that a process, method, item, or device that includes a series of elements not only includes those elements, but also includes other elements not explicitly listed, or also includes inherent elements of such process, method, item, or device. Without further limitations, an element defined by a statement “including one . . . ” does not exclude an existence of other identical elements in the process, method, item, or device that includes other same elements.

Although the embodiments of the present disclosure have been shown and described, it will be understood by those skilled in the art that various changes, modifications, substitutions, and variations can be made to these embodiments without departing from principles and spirit of the present disclosure. A scope of the present disclosure is limited by the appended claims and their equivalents.

What is claimed is:

1. An automatic proportioning and spray system for a compound ultra-fine dust capture agent, comprising: a protective bin (1), wherein a raw material enclosure (11) and a mixing enclosure (13) are arranged inside the protective bin (1); a control module (14) is set on one side of an outer surface of the protective bin (1), a funnel (12) is set on a surface of the mixing enclosure (13) of the protective bin (1), an agent hopper (15) is set on a surface of the raw material enclosure (11) of the protective bin (1), and a spraying device (16) is set on an other side of the outer surface of the protective bin (1), wherein the automatic proportioning and spray system for the composite ultra-fine dust capture agent further comprises: an anti sedimentation quantitative feeding mechanism (2) and a multi-function mixing and stirring mechanism (3);
wherein the anti sedimentation quantitative feeding mechanism (2) is set in the raw material enclosure (11), and the anti sedimentation quantitative feeding mechanism (2) is used for automatic proportioning and anti precipitation of dust capture agent; and
wherein the multi-function mixing and stirring mechanism (3) is set in the mixing enclosure (13), and the multi-function mixing and stirring mechanism (3) is used for uniform mixing of dust capture agent.

2. The automatic proportioning and spray system for a compound ultra-fine dust capture agent according to claim 1, wherein the anti sedimentation quantitative feeding mechanism (2) comprises: a pretreatment pipe (21), wherein a first end and a second end of the pretreatment pipe (21) are rotatably set on an inner wall of the raw material enclosure (11); the pretreatment pipe (21) is vertically fixed and connected through two circular branch pipes; and the first end of the pretreatment pipe (21) is connected to the agent hopper (15); and wherein a driving device is set on an outer side of the raw material enclosure (11), and a driving shaft of the driving device is fixedly set at the second end of the pretreatment pipe (21).

3. The automatic proportioning and spray system for a compound ultra-fine dust capture agent according to claim 2, wherein an aggregate pipe (22) is fixedly connected in a middle of the pretreatment pipe (21), wherein a middle of the aggregate pipe (22) is equipped with a liquid outlet hole and a fixed ring (23) is set on an outer surface of the liquid outlet hole; a sliding pipe (24) is set in a middle of the fixed ring (23) in a sliding manner, a liquid outlet groove is set at a first end of the sliding pipe (24), and a conical liquid outlet block (26) is fixedly connected at a second end of the sliding pipe (24).

4. The automatic proportioning and spray system for a compound ultra-fine dust capture agent according to claim 3, wherein a reset spring (25) is set on an outer surface of the sliding pipe (24), a first end of the reset spring (25) is fixedly set on the fixed ring (23), and a second end of the reset spring (25) is fixedly set on a surface of the conical liquid outlet block (26); wherein a curved extrusion plate (27) is set on each of two sides of an outer surface of the conical liquid outlet block (26); a curved extrusion groove is set on each curved extrusion plate (27), and is coaxially set with the aggregate pipe (22); a liquid collection bin (28) is set below the curved extrusion plates (27) set on two sides of the outer surface of the conical liquid outlet block (26), wherein a pressure boosting device (29) is set in the liquid collection bin (28), and the pressure boosting device (29) is fixedly connected to the funnel (12) through a pipeline.

5. The automatic proportioning and spray system for a compound ultra-fine dust capture agent according to claim 1, wherein the multi-function mixing and stirring mechanism (3) comprises: a transmission rod (31), which is rotatably set at a base of the mixing enclosure (13), wherein a scraper (32) is rotatably set at the base of the mixing enclosure (13), and a middle of the scraper (32) is fixedly set on an outer surface of the transmission rod (31).

6. The automatic proportioning and spray system for a compound ultra-fine dust capture agent according to claim 5, wherein two stirring shafts (33) are set at an end of the transmission rod (31) away from the scraper (32), and filtrate holes are uniformly set on each of the two stirring shafts (33), wherein an extrusion rod (34) is fixed on each of both sides of each of the two stirring shafts (33).

7. The automatic proportioning and spray system for a compound ultra-fine dust capture agent according to claim 6, wherein two circular baffle plates (35) are symmetrically set on an inner wall of the mixing enclosure (13), and guide grooves (37) are uniformly set at both ends of each of the two circular baffle plates (35); wherein an arc-shaped extrusion groove (38) is set on an inner surface of each of the two circular baffle plates (35), and two ends of the extrusion rod (34) are slidably set in the arc-shaped extrusion groove (38); wherein elastic telescopic rods (36) are uniformly set in the mixing enclosure (13), and a first end of each of the elastic telescopic rods (36) is set on a first one of the two circular baffle plates (35) and a second end of each of the elastic telescopic rods (36) is set on a second one of the two circular baffle plates (35).
